(19) United States
(12) Patent Application Publication
(10) Pub. No.: US 2018/0335505 A1
(43) Pub. Date: Nov. 22, 2018

(54) DEVICE FOR PROTECTING AN OPTICAL SENSOR AND ASSOCIATED DRIVING ASSISTANCE SYSTEM

(71) Applicant: Valeo Systèmes d'Essuyage, Le Mesnil Saint Denis (FR)

(72) Inventors: Frédéric Bretagnol, Issoire (FR); Denis Garnier, Bobigny (FR); Nicolas Pinchon, Bobigny (FR); Giuseppe Grasso, Issoire (FR); Marcel Trebouet, Le Mesnil Saint Denis (FR)

(73) Assignee: Valeo Systèmes d'Essuyage, Le Mesnil Saint Denis (FR)

(21) Appl. No.: 15/981,421

(22) Filed: May 16, 2018

(30) Foreign Application Priority Data
May 17, 2017 (FR) 1754341

(51) Int. Cl. G01S 7/481; G02B 3/04; G02B 27/00; G01J 1/04; G01S 17/93; B60R 11/04

(52) U.S. Cl. CPC G01S 7/4813; G02B 3/04; G02B 27/0006; B60R 2011/004; G01S 17/936; B60R 11/04; G01J 1/0411

(57) ABSTRACT

The invention relates to a device (3) for protecting an optical sensor (13) for a motor vehicle, said optical sensor (13) comprising an optic (14). According to the invention, the protecting device (3) includes an optical element (9) that is configured to be placed upstream of the optic (14) of the optical sensor (13) and that has at least one surface (9a, 9b) of aspheric general shape. The invention also relates to a corresponding driver-assistance system.

The present invention relates to the field of assisting drivers and in particular to driver-assistance systems, which are installed in certain vehicles, the driver-assistance system possibly including an optical sensor, such as for example a camera comprising an objective, in particular comprising at least one lens. More particularly, the invention relates to a device for protecting such an optical sensor.

Currently, many motor vehicles are equipped with front-, rear- or even side-view cameras. They in particular form part of driver-assistance systems, such as parking-assistance systems, or even systems for detecting lane departure.

Cameras that are installed in the interior of the passenger compartment of a vehicle against the rear windscreen/window and that point backward through the rear windscreen of the vehicle are known. These cameras are well protected from exterior climatic events and grime caused by mineral or organic pollutants. However, the angle of view for such cameras, installed in the interior of the passenger compartment, is not optimal, in particular for a parking-assistance systems, for example because they do not allow obstacles located in proximity to the rear of the vehicle to be seen.

For this reason, it is therefore preferred to install the cameras of driver-assistance systems on the exterior of vehicles in various locations depending on the desired use, for example level with the front or rear bumper, or level with the front or rear number plate of the vehicle. In this case, the camera is therefore highly exposed to being spattered with organic or mineral dirt that may be deposited on its optic and thus decrease its effectiveness, or even make it inoperative. In particular, during periods of wet weather, rain and dirt is observed to spatter, this spatter possibly greatly affecting the operability of the driver-assistance system comprising such a camera. The surfaces of the optics of these cameras must be cleaned in order to guarantee they remain in a good operating state.

To counter the deposition of dirt on the camera, it is known to arrange a device for cleaning the optic of the camera, generally a sprayer of cleaning liquid, in proximity thereto, in order to remove the polluting elements that are deposited over time. However, the use of these sprayers leads to an increase in the operating cost of such a driver-assistance system because they require quite large amounts of cleaning liquid to be used.

According to one known solution, means for vibrating a protecting window of the camera are provided in order to shed dirt from the protecting window of the camera. However, it has been observed that the effectiveness of such a device for tenacious and encrusted grime may be limited despite the vibration of the protecting window.

According to another solution, the camera is arranged in a protecting device. However, such a protecting device is very bulky to install.

In addition, the use of such a protecting device does not always allow a large angle of view to be achieved.

The present invention proposes to at least partially remedy the aforementioned drawbacks by providing an alternative device for protecting an optical sensor, allowing the deposition of grime on an optical sensor, such as a camera, to be prevented while preserving a large angle of view.

To this end, one subject of the invention is a device for protecting an optical sensor for a motor vehicle, said optical sensor comprising an optic, characterized in that the protecting device includes an optical element that is configured to be placed upstream of the optic of the optical sensor and that has at least one surface of aspheric general shape.

The one or more aspheric shapes allow a compact protecting device to be obtained without excessive deviation of rays, and therefore without excessive degradation of the optical performance of the optical sensor that will be placed behind such an optical element.

It will be understood that the one or more aspheric shapes are defined for each surface with respect to its general profile, independently of the surface finish and roughness of this surface. By way of example, if one or more bumps are produced on the surface of the optical element in order to obtain an optical effect, for example a scattering effect, or to prevent liquid from stagnating on the surface, these bumps are not considered to participate in the definition of the general shape of the optical element and they are therefore not considered in the evaluation of the aspheric character thereof.

Said device for protecting the optical sensor may furthermore have one or more of the following features, individually or in combination:
the optical element is at least partially transparent;
said at least one surface is a hyperbolic surface;
the bow of said at least one surface of the optical element as a function of the radial distance to the optical axis of the optical element is given by Equation (a):

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8}$$

in which:
   c corresponds to the curvature of the surface of the optical element;
   r corresponds to the radial distance to the optical axis;
   k corresponds to the conic constant; and
   α_{i [1, . . . , 4]} correspond to aspheric coefficients.
the conic constant is lower than −1 and preferably lower than −50;
the conic constant is comprised between −50 and −200;
the curvature of said at least one surface of the optical element is comprised between 1/15 mm⁻¹ and ⅕ mm⁻¹;
the optical element has an internal surface and an external surface that are opposite and such that the internal surface and the external surface have different aspheric general shapes;
the internal surface and the external surface respect Equation (a);
the conic constant of the Equations (a) of the bow of the internal surface and of the external surface of the optical element are different;
the aspheric coefficients of the Equations (a) of the bow of the internal surface and of the external surface of the optical element are different;
the optical element is configured to be arranged at a distance smaller than 5 mm from the optic of the optical sensor, and preferably smaller than 3 mm from the optic of the optical sensor;
the optical element is configured to be placed upstream of the optic of the optical sensor so that the optical axis of the optical element is coincident with the optical axis of the optical sensor;
the optical element is mounted so as to be able to rotate about the axis of rotation;
the optical element is placed centred with respect to its axis of rotation;
the optical element is arranged upstream of the protecting device so as to face a road scene images of which the optical sensor is configured to participate in capturing;
said device includes a housing that is securely fastened to the optical element and that has a compartment that is configured to receive the optical sensor;
the internal surface has an anti-fog property, the internal surface of said optical element in particular having an anti-fog coating;
the internal surface and/or the external surface has at least one property chosen from the following list: infrared filter, photocatalytic, hydrophobic, superhydrophobic, lipophobic, hydrophilic, superhydrophilic, stone-chip resistant.

The invention also relates to a driver-assistance system including an optical sensor comprising an optic. According to the invention, said system includes a device for protecting the optical sensor such as defined above.

According to one aspect of the invention, the optical element is separate from the optical sensor.

Other features and advantages of the invention will become more clearly apparent on reading the following description, which is given by way of nonlimiting illustrative example, and the appended drawings, in which:

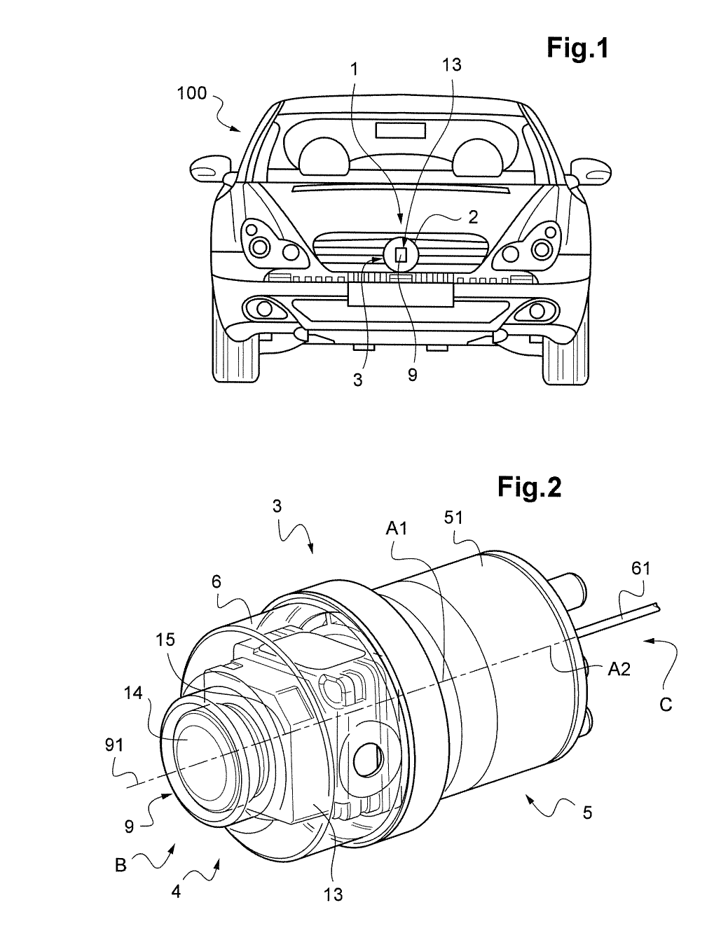

FIG. 1 schematically shows a motor vehicle comprising a driver-assistance system according to the invention;

FIG. 2 is a perspective view of a device for protecting an optical sensor of the driver-assistance system of FIG. 1;

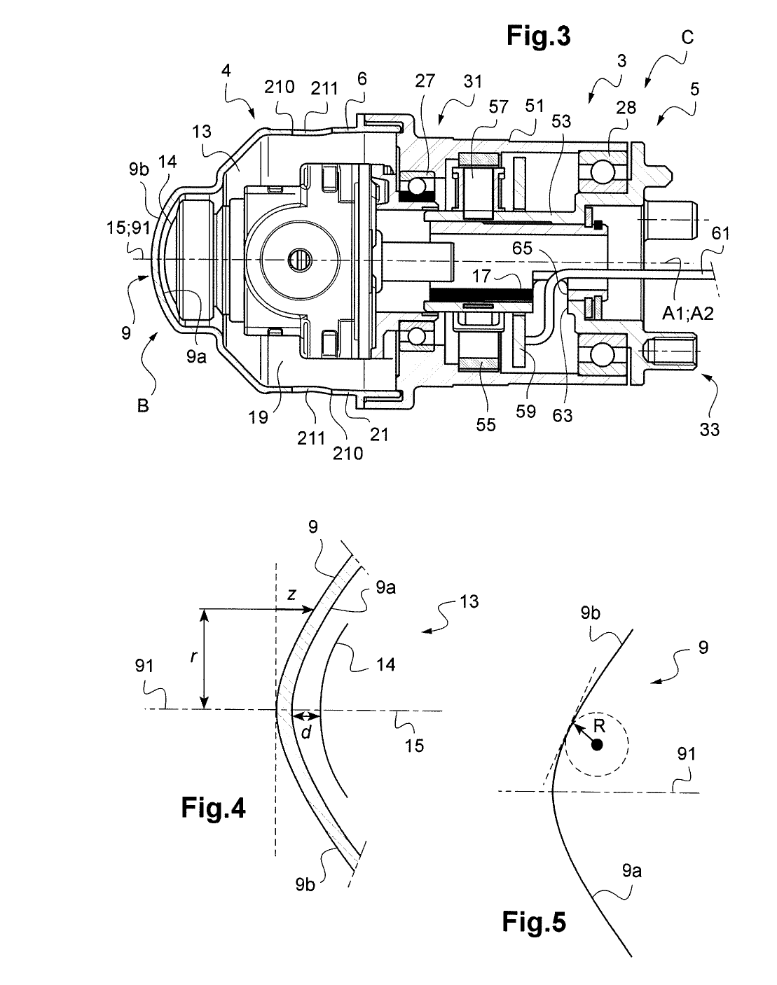

FIG. 3 is a partial longitudinal cross-sectional view of the protecting device of FIG. 2;

FIG. 4 is a view partially and schematically showing an optical sensor of the driver-assistance system and an optical element for protecting the optical sensor;

FIG. 5 schematically shows a surface of aspheric general shape of the optical element;

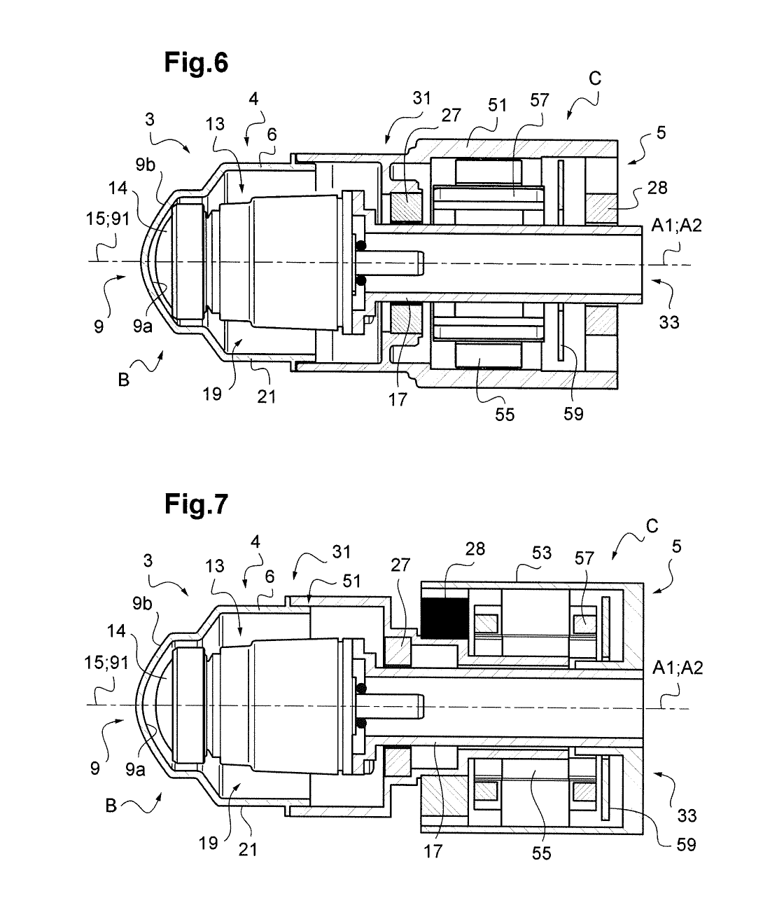

FIG. 6 is one variant of the protecting device; and

FIG. 7 is another variant of the protecting device.

In these figures, identical elements have been referenced with the same references.

The following implementations are examples. Although the description refers to one or more embodiments, this does not necessarily mean that each reference relates to the same embodiment, or that the features apply only to just one embodiment. Single features of various embodiments can also be combined or interchanged in order to create other embodiments

In the description, certain elements, such as for example the first element or second element, may be indexed. In this case, the index is simply used to differentiate and denote elements that are similar but not identical. This indexing does not imply a priority of one element with respect to another and such denominations may easily be interchanged without departing from the scope of the present invention. This indexing also does not imply an order in time.

FIG. 1 shows a motor vehicle 100 equipped with at least one driver-assistance system 1 according to the invention.

The driver-assistance system 1 in particular includes at least one optical sensor 13 and a device 3 for protecting the optical sensor 13, which is shown in FIGS. 2 and 3.

The optical sensor 13 (see FIGS. 1 to 3) is for example an image-capturing optical sensor 13 such as a camera. It may be a question of a CCD (charge-coupled device) sensor or a CMOS sensor including a matrix array of miniature photodiodes. According to another variant, it may be a LIDAR sensor, LIDAR standing for “light detection and ranging”.

As may be more clearly seen in FIGS. 2 and 3, the optical sensor 13 includes an optic 14 of optical axis 15. The optic 14 is for example an objective. An objective may include at least one lens, and in particular, depending on the field of view and resolution, a plurality of lenses, for example between two and ten lenses, generally four or five lenses, or even ten lenses in the case of a fish-eye. At least one of the lenses of the optic 14 is convex (curved), its convexity for example being oriented towards the exterior of the optical sensor 13 such as a fish-eye.

The optical sensor 13 may in addition include a portion forming a holder 17 (FIG. 3) of the optical sensor 13. It is here a question of a rear portion of the optical sensor 13, on the side opposite to the optic 14.

In the illustrated embodiment, the optical sensor 13 is intended to be mounted in the protecting device 3. More precisely, the optical sensor 13 and in particular its holder 17 are intended to be fixedly mounted in the protecting device 3.

In the example illustrated in FIG. 1, the protecting device 3 is installed at the front of the vehicle 100 level with a bumper. Of course, as a variant, the protecting device 3 may be installed at the rear of the vehicle 100, for example level with the bumper or number plate. It may also for example be installed on the sides of the vehicle, for example level with the rearview mirrors.

The protecting device 3 may be fastened, using any known technique, to any element 2 of the vehicle 100, such as to an element of the body or to an exterior element such as a bumper, a rearview mirror or a number plate. For this purpose, mention may be made, non-exhaustively, of a system of clips, a screwing system, or even an adhesive-bonding system.

Protecting Device

More precisely, with reference once again to FIGS. 2 and 3, the protecting device 3 includes:
at least one accessory 4 for a motor vehicle 100 (the reader is also referred to FIG. 1), this accessory 4 being mounted so as to be able to rotate about an axis of rotation A1 and having the function of protecting the optical sensor 13; and
an actuator, and more precisely a motor 5, that is configured to drive the accessory 4 to rotate.

The protecting device 3 is therefore a motorized device.

In particular, the protecting device 3 may include a first subassembly B and a second subassembly C that are separate from and assembled with each other. The first subassembly B may form the accessory 4 for a motor vehicle 100. The second subassembly C may include the motor 5, in order to drive the first subassembly B to rotate.

Accessory

The accessory 4 or protecting means may be at least partially transparent.

In the described embodiment, the accessory 4 includes an optical element 9. In this embodiment, the accessory 4, and more generally the protecting device 3 also advantageously includes a housing 6 that is securely fastened to the optical element 9.

The optical element 9 and the housing 6 may form a single part. Alternatively, the housing 6 and the optical element 9 may be two separate securely-fastened parts.

The optical element 9 and the housing 6 are described in more detail below.

The optical element 9, which may be more clearly seen in FIGS. 2 to 4, is intended to protect the optic 14 of the optical sensor 13 from potential spatter with grime or solid debris that could damage this optic 14. It is therefore a question of an element for protecting, or more precisely a mask for protecting, the optical sensor 13, and it is this optical element 9 that is subjected to aggressions originating from the exterior, i.e. to water spatter, pollutants, small pieces of stone, but also pollutant deposits or water stains.

In the described embodiment, the optical element 9 is separate from the optical sensor 13.

This optical element 9 has an optical axis 91.

The optical element 9 is arranged upstream of the protecting device 3. In this example, the optical element 9 is arranged at the front of the protecting device 3. In other words, the optical element 9 is arranged at the front of the accessory 4, or even at the front of the housing 6. The expression “front of the protecting device 3” is understood to mean the portion intended to be placed facing the road scene images of which the optical sensor 13 participates in capturing, when the protecting device 3 is installed in the vehicle 100 (FIG. 1). In contrast, the rear of the protecting device 3 is the portion opposite the front; it is therefore a question of the portion that is furthest from the road scene images of which the optical sensor 13 participates in capturing.

More precisely, the optical element 9 is intended to be placed upstream of the optical sensor 13, and more precisely upstream of the optic 14. In the present text, the term upstream is defined with respect to the optical axis 15 and with respect to the road scene images of which the optical sensor 13 participates in capturing. In other words, the expression “upstream of the optic 14” is understood to mean a position in which the optical element 9 is placed between the optic 14 and the road scene images of which the optical sensor 13 participates in capturing, along the optical axis 15.

This optical element 9 is advantageously dimensioned so as to cover all of the surface of the optic 14.

Arranged in the field of view of the optical sensor 13, the optical element 9 is advantageously transparent in order not to decrease the effectiveness of the optical sensor 13. This optical element 9 may be made of glass or of a transparent plastic such as polycarbonate.

The optical element 9 may be arranged centred with respect to the optical sensor 13, and more precisely centred with respect to the optic 14. The optical element 9 is arranged so that its optical axis 91 is coincident with the optical axis 15 of the optical sensor 13 (see FIG. 4).

Furthermore, the optical element 9 has at least one surface 9a, 9b of aspheric general shape. More precisely, that portion of the optical element 9 which is intended to be arranged directly facing the optic 14 has this or these surfaces 9a, 9b of aspheric general shape.

The aspheric surfaces 9a and 9b of the optical element 9 do not, respectively, closely fit to the shape of a sphere. In other words, the curvature of such an aspheric surface 9a, 9b is not constant at every point, in contrast to that of a sphere. The optical element 9 therefore does not have a simple spherical shape but is of more complex shape.

It should be noted that the optical element is here of aspheric shape, i.e. its shape is similar to a spheric shape, and that this aspheric shape must be considered for a given thickness of the optical element, which thickness is defined between a profile defining the internal surface of the optical element and a profile defining the external surface of this optical element. It is the general profiles of the external and/or internal surfaces that must be considered, and the presence of bumps and/or studs on the external surface in particular of the optical element is not to be taken into account here in the definition of the aspheric shape of the optical element.

The bow z of each aspheric surface 9a, 9b as a function of the radial distance r to the optical axis 91 of the optical element 9 is given by the following equation, Equation (a):

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} \qquad ( a )$$

In this Equation (a), the parameter c corresponds to the curvature of the surface of the optical element 9. This parameter c is the inverse of the radius of curvature R (see FIG. 5). The radius of curvature R varies with the distance to the optical axis 91. At any particular point, the radius of curvature R may be defined as that of the circle tangent to the surface of the point in question. Such a circle is called an osculating circle. Such a circle is schematically represented by a dashed line in FIG. 5. In one particular example embodiment, the radius of curvature R is comprised between 5 mm and 15 mm. The curvature c is therefore comprised between 1/15 mm⁻¹ and ⅕ mm⁻¹.

In addition, in Equation (a), the parameter r corresponds to the radial distance to the optical axis 91, as schematically shown in FIG. 4.

The parameter k, which is not shown in the figures, corresponds to the conic constant, also called the conicity constant. It is a question of a mathematical value that is representative of the variation in the curvature of the surface between its central portion and its edges. In other words, the parameter k characterizes the variation in the radius of curvature R with distance from the apex. This variation provides the surfaces that possess this property of asphericity with particular optical properties.

Lastly, the parameters α_{i [1, . . . , 4]} correspond to aspheric coefficients. In the Equation (a) given above, the polynomial terms α₁r² to α₄r⁸ extend up to a power of 8 of the radial distance r, but of course there may be fewer of these polynomial terms or, in contrast, more thereof.

These aspheric coefficients αᵢ are very low and in particular lower than 1. By way of nonlimiting example, α₁ is comprised between 0.01 and 0.1; α₂ between −10⁻⁵ and −10⁻⁶; α₃ between 10⁻⁹ and 10⁻¹⁰; and α₄ between 10⁻¹⁰ and 10⁻¹¹.

In one particular example, the aspheric surface forms a conic section.

In this case the aspheric coefficients αᵢ are zero. The bow z of the optical element 9 as a function of the radial distance r to the optical axis 91 of the optical element 9 is then given by the following equation, Equation (b):

$$z = \frac{{cr}^{2}}{1 + \sqrt{1 - ( 1 + k ) {c}^{2} {r}^{2}}} \qquad ( b )$$

In this Equation (b), the parameters c, k, r are the same as in Equation (a). In other words, Equation (b) corresponds to Equation (a) but without the coefficients αᵢ.

Depending on the value of the conic constant k, the aspheric surface 9a, 9b may have various conic shapes, such as elliptic, parabolic or even hyperbolic shapes.

According to one preferred embodiment, at least one surface 9a, 9b of the optical element 9 is of hyperbolic general shape. The bow z of the surface 9a, 9b of hyperbolic general shape is given by Equation (b). Furthermore, in this Equation (b), the conic constant k is lower than −1, and in particular very much lower than −1. Preferably, the conic constant k is lower than −50, the conic constant k in particular being comprised between −50 and −200.

Moreover, the optical element 9 has an internal surface 9a and an external surface 9a that are opposite. The internal surface 9a and the external surface 9b each have an aspheric general shape, and in particular a hyperbolic general shape. The aspheric shapes, or more precisely the hyperbolic shapes, of the internal surface 9a and the external surface 9b of the optical element 9 are different. As above, it is the general profile of the internal surface and of the external surface that must be considered when evaluating the aspheric shape, and in particular the hyperbolic shape, and the roughness of this surface and the presence of bumps or studs sculpting the surface finish must be ignored.

In particular, the conic constant k of the internal surface 9a is different from the conic constant k of the external surface 9b. In one particular nonlimiting example embodiment, the conic constant k is about −159 for one of the surfaces and −76 for the other surface.

Furthermore, the aspheric coefficients αᵢ are different in Equation (a) for the bow z of the internal surface 9a and in Equation (a) for the bow z of the external surface 9b.

Of course, alternatively, the internal surface 9a and external surface 9b may be parallel, i.e. both these surfaces 9a and 9b may have the same conic constant k and the same coefficients αᵢ in Equation (a) for the bow z.

Moreover, the respective aspheric surfaces 9a and 9b of the optical element 9 may be convex or concave. In this example, the optical element 9 is of convex general shape. In the illustrated example, it is that portion of the optical element 9 which is intended to be arranged in the field of view of the optical sensor 13 that has this substantially convex shape. Thus, the aspheric surfaces 9a, 9b of the optical element 9 are convex with their convexities oriented towards the exterior of the protecting device 3.

In addition, the optical element 9 may be arranged at a distance d from the optic 14 (see FIG. 4) that is smaller than 5 mm, or even at a distance smaller than 3 mm from the optic 14, for example at a distance of about 2 mm. The optical element 9 may therefore be arranged very close to the optic 14 while preserving a large angle of view, in particular an angle of view larger than 110° and for example of about 190°, and a good optical performance by virtue of the aspheric surfaces 9a, 9b. This allows the protecting device 3 to be made very compact. Specifically, the aspheric surfaces 9a, 9b provide a better optical performance with respect to an optical element produced with surfaces of constant sphericity. The hyperbolic general shape of the internal surface 9a and external surface 9b of the optical element 9 is in particular advantageous for such a small distance d between the optic 14 and the optical element 9.

Lastly, the optical element 9 may have a very small thickness, for example of about one millimetre.

Moreover, the optical element 9 is mounted so as to be able to rotate about an axis of rotation A1, which is schematically shown in FIGS. 2 and 3.

Advantageously, the axis of rotation A1 of the optical element 9 is coincident with the optical axis 15 of the optical sensor 13. This axis of rotation A1 is also coincident with the optical axis 91 of the optical element 9.

The optical element 9 may be placed centred with respect to the axis of rotation A1. This optical element 9 is in particular axisymmetric with respect to the axis of rotation A1.

Moreover, when the protecting device 3 that accommodates the optical sensor 13 is installed in the vehicle 100 (the reader is also referred to FIG. 1), the optic 14 and the optical element 9 advantageously protrude from an aperture provided in the element 2 of the vehicle 100. With such an arrangement, the optical sensor 13 has a large angle of view and the optic 14 remains clean because of the presence of the optical element 9 between the optic 14 and the exterior of the vehicle 100 (FIG. 1).

Furthermore, in order to prevent condensation forming between the optic 14 and the optical element 9, the internal surface 9a of the optical element 9 (see FIGS. 3-5) advantageously has an anti-fog property. The internal surface 9a of the optical element 9 is the surface intended to be arranged facing the optic 14 of the optical sensor 13. In particular, the internal surface 9a of the optical element 9 has an anti-fog coating.

As a variant or in addition, the internal surface 9a and/or the external surface 9b of the optical element 9 may have one or more of the following properties: hydrophobic, infrared filter, photocatalytic, superhydrophobic, lipophobic, hydrophilic, or even superhydrophilic, stone-chip resistant, or even any other surface treatment allowing the adhesion of grime to be decreased. In particular, by virtue of the hydrophobic properties of the external surface of the optical element 9, any water droplets will run off the external surface without leaving stains because the water will not be able to adhere to this external surface. Thus, the layers or coatings on the external surface 9b of the optical element 9 allow the possibility of adherence of mineral or organic pollutants and the presence of water stains on the optical element 9, which could adversely affect correct operation of the driver-aid 1, to be limited. Advantageously, a liquid solution, such as a solution of the Rain-X® type, may be deposited on the external surface 9b of the optical element 9 in order to form a hydrophobic pellicule.

These example embodiments are given by way of nonlimiting illustration. For example, those skilled in the art may use a transparent optical element 9 having an external surface 9b having other properties allowing the adherence of grime to this external surface 9b to be limited without departing from the scope of the present invention.

Optionally, the optical element 9 of the protecting device 3 may also comprise an integrated defrosting or demisting system in order to make it possible to guarantee that the driver-aid 1 is able to operate correctly whatever the meteorological conditions, such as a defrosting resistor or filament for example.

With reference again to FIGS. 2 and 3, as regards the housing 6, the latter is mounted so as to be able to rotate about the axis of rotation A1.

Preferably, the housing 6 is a seal-tight housing. The housing 6 may be made of any suitable material known to those skilled in the art.

More precisely, this housing 6 is arranged so as to be driven to rotate by the motor 5, this allowing the optical element 9 to rotate. The optical element 9 is therefore, in this particular example, configured to be driven to rotate with the housing 6, so as to allow the optical element 9 to be cleaned via a centrifugal effect.

The optical element 9 is configured to be placed at the front of the housing 6. The expression “front of the housing 6” is understood to mean that portion of the housing 6 which is intended to be placed facing the road scene images of which the optical sensor 13 participates in capturing, when the protecting device 3 is installed in the vehicle 100 (the reader is also referred to FIG. 1). In contrast, the expression “rear of the housing 6” is understood to mean that portion of the housing 6 which is opposite the front of the housing 6 and it is therefore the portion that is furthest from the road scene images of which the optical sensor 13 participates in capturing.

In addition, the optical sensor 13 is, in this example, at least partially mounted in the housing 6. To achieve this, the housing 6 includes a compartment 19 (see FIG. 3) that is configured to accommodate the optical sensor 13, for example so that the optical axis 15 of the optical sensor 13 is coincident with the axis of rotation A1 of the housing 6.

More precisely, the housing 6 includes a wall 21 defining the compartment 19 for the optical sensor 13. This wall 21 may be centred on the axis of rotation A1 of the optical element 9 and of the housing 6. In this example, the wall 21 is of substantially cylindrical general shape.

According to a first variant, the wall 21 and the optical element 9 may form a single part. According to a second variant, the wall 21 and the optical element 9 may be two separate parts, and in this case the wall 21 is securely fastened to one end of the optical element 9. In particular the front end of the wall 21 is securely fastened to the optical element 9. By way of nonlimiting example, the wall 21 and the optical element 9 may be securely fastened by ultrasonic welding. Thus, the housing 6 and the optical element 9 may be one or more parts. Since the housing 6 is securely fastened to the optical element 9, a seal-tight unit is formed that thus prevents grime from getting into the interior of the housing 6 that is intended to accommodate the optical sensor 13.

As a variant or in addition, provision is advantageously made for at least one means for limiting condensation, this means being referred to below as the anti-condensation means. Such an anti-condensation means may be integrated into the housing 6. In particular, at least one anti-condensation means may be arranged on the wall 21 of the housing 6.

By way of nonlimiting example, the anti-condensation means may comprise at least one through-orifice 210 in the housing 6, in this example in the wall 21 (see FIG. 3). The one or more orifices 210 may be produced by drilling. Preferably, when a plurality of orifices 210 are provided, they are arranged symmetrically with respect to the axis of rotation A1 of the housing 6.

In the example illustrated in FIG. 3, two orifices 210 are provided, said orifices being arranged symmetrically with respect to the axis of rotation A1 of the housing 6. The orifices 210 communicate between the interior of the housing 6 and the exterior of the housing 6 when the protecting device 3 has been assembled. By way of nonlimiting example, each orifice 210 may have a diameter of about 5 mm.

In addition, provision may be made for one or more semipermeable membranes 211, said membranes being arranged at least in one orifice 210, respectively. In the example illustrated in FIG. 3, two membranes 211 have been schematically shown. Each membrane 211 may be seal-tight fastened to an associated orifice 210, for example by adhesive bonding or even by ultrasonic welding. These membranes 211 are, in the described embodiments, permeable to air and impermeable to water. The one or more membranes 211 thus promote the circulation of air in the interior of the housing 6. This allows good ventilation to be achieved between the optic 14 and the optical element 9 and thus prevents condensation from accumulating.

Advantageously, provision is furthermore made for at least one means for compensating for the lesser weight of the orifice 210 or orifices 210. In the particular example illustrated in FIG. 3, the two membranes 211 are placed symmetrically with respect to the axis of rotation A1 of the housing 6 and it is this symmetric arrangement that allows weight effects to be limited with respect to the centrifugal force during the rotation of the housing 6.

Motor

As regards the motor 5, various variants thereof are shown in FIGS. 2, 3, 6 and 7; it may in particular be an electric motor of small size, or even a miniature electric motor.

The expression “electric motor of small size” is understood to mean, in the context of the present invention, a stepper motor, an actuator, a brushed or brushless DC motor, an asynchronous motor or a synchronous motor, the weight of which is lower than 10 kg, or even lower than 1 kg, and that is in particular used to actuate equipment in vehicles.

The expression “miniature electric motor” is understood to mean, in the context of the present invention, a stepper motor, an actuator, a brushed or brushless DC motor, an asynchronous motor or a synchronous motor, the weight of which is lower than 200 g, or even lower than 100 g, and preferably comprised between 30 g and 100 g, and for example between 30 g and 60 g.

The motor 5 includes a rotor 51 and a fixed stator 53, the rotor 51 being able to rotate with respect to the fixed sator 53.

The motor 5 is coupled to the housing 6 in order to drive the housing 6 and the optical element 9 to rotate. In the described embodiment, the housing 6 and the optical element 9 are securely fastened to the rotor 51 of the motor 5.

In the embodiment illustrated in FIGS. 2, 3 and 6, the rotor 51 is placed around the stator 53. The stator 53 is therefore internal and the rotor 51 external. Moreover, in the example of FIG. 6, the stator 53 may form the holder 17 of the optical sensor 13. In other words, the holder 17 and the stator 53 form a single part.

Alternatively, as illustrated in FIG. 7, the stator 53 may be arranged around the rotor 51.

Moreover, in the various embodiments illustrated in FIGS. 2, 3, 6 and 7, the motor 5 is arranged to the rear of the protecting device 3, and more precisely the motor 5 is assembled with the rear of the housing 6. In other words, the motor 5 is arranged on the side opposite to the optical to element 9.

Thus, a seal-tight unit is formed that thus prevents grime from getting into the interior of the housing 6 that is intended to accommodate the optical sensor 13.

Furthermore, the motor 5 is in this example arranged in the extension of the optical sensor 13.

The motor 5 is advantageously a hollow motor 5. It may at least partially receive the optical sensor 13.

In the configuration illustrated in FIG. 3 with the internal stator 53 and the external rotor 51, the stator 53 may at least partially receive the holder 17 of the optical sensor 13.

In the configuration illustrated in FIG. 6, with the external rotor 51 and the stator 53 forming the optical holder 17, the hollow rotor 51 may at least partially receive the stator 53 forming the holder 17 of the optical sensor 13.

In the configuration illustrated in FIG. 7, with the internal rotor 51, it is the latter that may at least partially receive the holder 17 of the optical sensor 13.

The motor 5 is for example supplied with electrical power by a power supply that is connected to the general electrical circuit of the vehicle 100 (the reader is also referred to FIG. 1).

By way of nonlimiting example, the motor 5 may more particularly be a brushless motor. In the example illustrated in FIG. 3, the motor 5 comprises at least one magnet 55 that is securely fastened to the rotor 51, and a predefined number of electromagnetic coils 57, in particular at least three electromagnetic coils 57 that are mounted on the stator 53. The electromagnetic coils 57 are intended to be supplied with power in order to allow the magnet 55 that is securely fastened to the rotor 51 to be driven. The motor 5 comprises, for this purpose, a circuit 59 for controlling the supply of power to the electromagnetic coils 57. This control circuit 59 may be connected to a power-supply wiring harness 61 that is connected to the general electric circuit of the vehicle 100 (the reader is also referred to FIG. 1).

The motor 5 may have a speed of rotation comprised between 1000 and 50000 revolutions/minute, preferably between 5000 and 20000 revolutions/minute, and even more preferably between 7000 and 15000 revolutions/minute. Such speeds of rotation allow any grime that has been deposited on the optical element 9 to be removed via a centrifugal effect and thus allow the optic 14 of the optical sensor 13 to be kept clean in order to ensure the driver-assistance system 1 operates optimally.

The motor 5 is configured to drive the accessory 4, namely in this example the housing 6 and the optical element 9 that is securely fastened to the housing 6, to rotate.

The motor 5 is mounted so as to be able to rotate about an axis of rotation A2. The motor 5 is for example arranged so that its axis of rotation A2 is coincident with the axis of rotation A1 of the optical element 9, and with the optical axis 15 of the optical sensor 13.

Moreover, provision is advantageously made for a seal-tight arrangement for the passage of cables or wires to the rear of the motor 5, in order to limit the ingress of water vapour and/or other contaminants into the interior of the protecting device 3.

The protecting device 3 therefore includes a movable portion 31, also called the rotating portion 31, and a fixed portion 33 (see FIG. 3).

The movable portion 31 comprises at least the rotor 51 of the motor 5, and the fixed portion 33 comprises at least the stator 53 of the motor 5.

The movable portion 31 of the motorized device 3 may also include at least one movable element that is securely fastened to the rotor 51, such as in particular the accessory 4, i.e. the housing 6 and the optical element 9 in this example.

Likewise, the fixed portion 33 may also comprise an element or holder that is fastened to the stator 53. Of course, the element or holder may or may not be fastened directly to the stator 53. Nonlimitingly, in this example, the fixed portion 33 of the motorized device 3 includes the fixed holder 17 of the optical sensor 13. This fixed holder 17 is in particular fastened to the stator 53.

The holder 17 of the optical sensor 13 and the stator 53 advantageously include respective complementary apertures 63, 65 in order to allow the control circuit 59 to be connected to the power-supply wiring harness 61.

Furthermore, the protecting device 3 may in particular comprise one or more bearings 27, 28, which are schematically shown in FIG. 3. In this example, the protecting device 3 comprises two bearings 27, 28.

These bearings 27, 28 are each arranged between the movable portion 31 and the fixed portion 33 of the protecting device 3. The bearings 27, 28 are of substantially annular general shape. In addition, the two bearings 27, 28 are arranged concentrically with the motor 5.

With reference to the particular example illustrated in FIG. 3, one of the bearings, for example the bearing 27 may be placed between the rotor 51 and a portion, in particular a front portion, of the holder 17 of the optical sensor 13. The other bearing, the bearing 28 in the example of FIG. 3, is placed between the rotor 51 and the stator 53 of the motor 5.

Alternatively, the two bearings 27 and 28 may be arranged between the rotor 51 and the stator 53. In particular, in the variant embodiment illustrated in FIG. 5, the two bearings 27, 28 are arranged between the rotor 51 and the stator 53 that forms the holder 17 of the optical sensor 13.

Moreover, at least one of these bearings 27, 28 may be a magnetic bearing. Such a magnetic bearing allows the noise and friction generally generated when a protecting device 3 using mechanical bearings is operated to be avoided.

According to one variant, one bearing may be magnetic and the other bearing may be a mechanical bearing such as a ball bearing. According to another variant, the motorized device 3 may comprise a single magnetic bearing.

Thus, by arranging, at only a few millimetres from the optic 14 of the optical sensor 13, an optical element 9 with surfaces 9a, 9b having such a complex aspheric or even hyperbolic shape, a compact protecting device 3 is obtained that protects the optic 14 of the optical sensor 13 from external grime while guaranteeing a relatively large field of view, for example of about 190°.

In addition, the rotation of this optical element 9, in particular via the housing 6, ensures that the field of view of the optical sensor 13 is always free and clean. The rotation of the optical element 9 ensures the removal of grime via the centrifugal force that the latter experiences.

1. A device for protecting an optical sensor for a motor vehicle, said optical sensor comprising an optic, the protecting device comprising:
an optical element that is configured to be placed upstream of the optic of the optical sensor and that has at least one surface of aspheric general shape.

2. The device according to claim 1, wherein said at least one surface is a hyperbolic surface.

3. The device according to claim 1, wherein the bow (z) of said at least one surface of the optical element as a function of the radial distance (r) to the optical axis of the optical element is given by Equation (a):
$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8}$$
in which:
c corresponds to the curvature of the surface of the optical element;
r corresponds to the radial distance to the optical axis;
k corresponds to the conic constant; and
α_{i [1, . . . , 4]} correspond to aspheric coefficients.

4. The device according to claim 3, wherein the conic constant (k) is lower than −50, the conic constant (k) being comprised between −50 and −200.

5. The device according to claim 3, wherein the curvature (c) of said at least one surface of the optical element is comprised between 1/15 mm⁻¹ and ⅕ mm⁻¹.

6. The device according to claim 1, wherein the optical element has an internal surface and an external surface that are opposite and such that the internal surface and the external surface have different aspheric general shapes.

7. The device according to claim 3, wherein the internal surface and the external surface respect Equation and the aspheric coefficients (αᵢ) of the Equations (a) of the bow (z) of the internal surface and of the external surface of the optical element are different.

8. The device according to claim 1, wherein the optical element is configured to be arranged at a distance smaller than 3 mm from the optic of the optical sensor.

9. The device according to claim 1, wherein the optical element is mounted so as to be able to rotate about an axis of rotation.

10. A driver-assistance system including an optical sensor comprising an optic; and a device for protecting the optical sensor according to claim 1.
